(19) United States
(12) Patent Application Publication
(10) Pub. No.: US 2006/0284415 A1
(43) Pub. Date: Dec. 21, 2006

(54) Medical gas and vacuum system

(76) Inventor: Albert A. McKay, Stoney Creek (CA)

Correspondence Address: Erik J. Overberger, Esq.;Fay, Sharpe, Fagan, Minnich & McKee, LLP, Seventh Floor, 1100 Superior Avenue, Cleveland, OH, 44114-2579, US

(21) Appl. No.: 11/373,317

(22) Filed: Mar. 10, 2006

Related U.S. Application Data
(60) Provisional application No. 60/662,394, filed on Mar. 16, 2005.

(51) Int. Cl. F16L 33/00

(52) U.S. Cl. 285/256; 285/259

(57) ABSTRACT

A medical gas and vacuum system of a medical facility includes at least one medical gas source located at the medical facility that is capable of providing a positive flow to deliver a supplied gas or a negative flow to vacuum a retrieved gas. A plurality of spaced apart outlet ports is disposed within the medical facility for discharging the supplied gas and vacuuming the retrieved gas. A pipeline network fluidly connects the at least one medical gas source to the plurality of outlet ports. The pipeline network includes a plurality of pipeline fluid components through which the gas flows. At least one axially swaged fitting fluidly connects at least a first fluid component of the plurality of pipeline fluid components to a second fluid component of the plurality of pipeline fluid components. The fitting includes a coupling body defining at least one bore for receiving the first fluid component. A plurality of seals extend radially into the at least one bore from the coupling body and a swage ring is fitting over the coupling body to seal and mechanically connect the plurality of seals to the first fluid component received in the at least one bore.

This application claims priority of Provisional Patent Application Ser. No. 60/662,394, filed Mar. 16, 2005, entitled “Fitting Suitable for Medical Gas and Vacuum Distribution Pipeline Systems” (Attorney Docket No. LKRZ 2 00045P), expressly incorporated herein by reference.

### BACKGROUND

The present disclosure generally relates to a medical gas and vacuum system, such as those often employed in medical facilities. More particularly, the present disclosure relates to a medical gas and vacuum system including at least one medical gas source located at a medical facility, a plurality of spaced apart outlet ports disposed within the medical facility, a pipeline network fluidly connecting the medical gas source to the plurality of outlet ports, wherein the pipeline network includes pipeline fluid components through which medical gas flows, and wherein at least one axially swaged fitting fluidly connects fluid components of the pipeline network to one another. The medical gas and vacuum system will be described with particular reference to this arrangement, but it is to be appreciated that it may relate to other similar environments and applications.

Medical facilities, including hospitals, nursing homes, clinics and other health care institutions, often utilize medical gases in rendering care to patients. It is well known to administer oxygen, air, nitrogen and nitrous oxide to patients for treatment of a variety of different conditions or during surgical operations. Medical gasses are often delivered through medical gas systems which provide the gasses throughout a particular medical facility or portions or zones thereof. In addition, the medical gas system often includes an evacuation system for creating a vacuum, also for use throughout a particular medical facility or portions or zones thereof. Many medical gas systems, as a result of the inclusion of an evacuation means, can be more specifically characterized as medical gas and vacuum systems.

Typically, a medical facility will employ a medical gas system having a central gas supply source for providing either a positive flow of treating gas or a negative flow of air to form a vacuum. These systems often utilize a network of conduits or supply lines to deliver the gas or supply the vacuum to specific treatment locations remote from the central source. The gas supply source may even be located externally or outside the physical walls of the medical facility it services. The network of conduits and supply lines can include main and branch shut-off valves for selective isolation of a portion of the network, such as may be desirable in the event of damage or fire or to effect needed repairs or expansion of the network. The system may additionally include manifolds with appropriate shut-off valves, pressure gauges, pressure regulators, check valves and pipe supply lines, typically of copper, for connecting the elements of the system. The system further includes fittings for connecting the various elements of the network together and for effecting turns, offsets and other changes in direction within the system.

Heretofore, the fittings of medical gas and vacuum systems were typically brazed wrought copper capillary fittings complying with ANSI (American National Standards Institute) specification B16.22, Wrought Copper and Copper Alloy Solder-Joint Fittings, or brazed fittings complying with MSS (Manufacturers Standardization Society) specification SP-73, Brazed Joints for Wrought and Cast Copper Alloy Solder Joint Pressure Fittings. The use of such compliant fittings also met the requirements of NFPA 99 Standards for Health Care Facilities. One drawback of the use of these types of compliant fittings is the resultant increased costs, particularly related to installation and/or maintenance of the fittings.

Another cost related to the use of fittings in medical gas and vacuum systems is associated with cleaning of the fittings for oxygen service prior to installation thereof. In particular, tubes, valves, fittings, station outlets and other piping components employed in a medical gas and vacuum system are typically required to be cleaned for oxygen service to prevent contamination within the system. Cleaning for oxygen service is sometimes done by continuous purging of the components, e.g., fittings, with oil-free, dry nitrogen NF, which prevents the formation of copper oxide on the inside surfaces of the purged elements. Obviously, cleaning the medical gas and vacuum system or a fitting to be installed in the medical gas and vacuum system further increases the costs of the system, particularly those associated with installation of fittings in the system.

One type of fitting, which has heretofore been overlooked for use in medical gas and vacuum systems, is a fitting which compresses against the outside diameter of the tube or pipe to create a seal, often employed where thin walled tubing or pipe is used. This fitting can include a coupling body and a swage ring which is forced over the coupling body to compress it radially inwardly against a tube or pipe received within the coupling body to create a mechanical connection and seal. Generally, this type of fitting has one or more circumferential teeth or ridges on an inside diameter of the coupling body which, when compressed inwardly by a swage ring, engage the outside diameter of the tube or pipe to create one or more leak-tight mechanical connections or joints between the tube or pipe and the fitting. This engagement of the sealing teeth of the fitting with the tube or pipe causes the pipe to be deformed radially inwardly, with the coupling body of the fitting located externally about the tube or pipe.

One main reason these types of fittings have not been used in medical gas and vacuum systems is that they are typically installed using a lubricant. Specifically, a lubricant, such as a dry film lubricant, is typically applied to an outside surface of the fitting body and an inside surface of the swage ring. The lubricant facilitates axial movement of the swage ring onto the fitting body. In particular, lubricant can have the effect of preventing or at least reducing the likelihood of the fitting's coupling body buckling during axial installation of the swage ring. Buckling can also be a concern when more malleable fittings are employed, such as those formed of brass. The use of these types of fittings with a lubricant can contaminate the fitting and make the fitting unsuitable for use in medical gas pipeline systems. Moreover, while some attempts have been made to manufacture swage ring fittings of brass that need not have a lubricant applied, the above-described buckling phenomena may result which could cause such a fitting to be rendered unsuitable for use.

### SUMMARY

In accordance with one aspect, a medical gas and vacuum system of a medical facility is provided. More particularly, in accordance with this aspect, at least one medical gas source is located at the medical facility. The at least one medical gas source is capable of providing a positive flow to deliver a supplied gas or a negative flow to vacuum a retrieved gas. A plurality of spaced apart outlet ports is disposed within the medical facility for discharging the supplied gas and vacuuming the retrieved gas. A pipeline network fluidly connects the at least one medical gas source to the plurality of outlet ports. The pipeline network includes a plurality of pipeline fluid components through which the gas flows. At least one axially swaged fitting fluidly connects at least a first fluid component of the plurality of pipeline fluid components to a second fluid component of the plurality of pipeline fluid components. The fitting includes a coupling body defining at least one bore for receiving the first fluid component. A plurality of seals extend radially into the at least one bore from the coupling body and a swage ring is fitting over the coupling body to seal and mechanically connect the plurality of seals to the first fluid component received in the at least one bore.

In accordance with another aspect, a lubrication-free fitting for making connections in a medical gas and vacuum system is provided. More particularly, in accordance with this aspect, the lubrication-free fitting includes a coupling body having an inside surface defining a bore for receiving a pipe of the medical gas and vacuum system. A ring is fitted over the coupling body for sealing and mechanically connecting the coupling body to the pipe. An axisymmetrical main seal is formed on the inside surface of the coupling body that seals and connects to the pipe when the ring is installed on the coupling body. An axisymmetrical inboard seal is formed on the inside surface of the coupling body. The inboard seal is axially spaced from the main seal. The inboard seal seals and connects to the pipe when the ring is installed on the coupling body. An axisymmetrical outboard seal is formed on the inside surface of the coupling body and is axially spaced from the main seal in a direction opposite the inboard seal. The outboard seal seals and connects to the pipe when the ring is installed on the coupling body.

In accordance with yet another aspect, a medical gas and vacuum system of a medical facility is provided. More particularly, in accordance with this aspect, the system includes at least one medical source located at the medical facility and at least one outlet port located inside the medical facility. At least one pipe supply line formed of at least first and second metal pipe supply members fluidly connects the at least one medical gas source to the at least one outlet port. At least one axially swaged fitting fluidly connects the at least first and second metal pipe supply line members to one another. The at least one axially swaged fitting includes a metal coupling body having a first open end and a second open end with a bore extending between the first and second open ends. The first pipe supply line member is received through the first open end into the bore and the second pipe supply line member is received through the second open end into the bore. A first plurality of seals is integrally formed with and extends from the coupling body into the bore from the inside surface. A first swage ring is fitted over the coupling body adjacent the first open end for permanently and nonseperably sealing and mechanically connecting the first plurality of seals with the first pipe supply line. A second plurality of seals is integrally formed with and extends from the coupling body into the bore from the inside surface. A second swage ring is fitted over the coupling body adjacent the second open end for permanently and nonseperably sealing and mechanically connecting the second plurality of seals with the second pipe supply line member. The first and second sets of the plurality of seals each include a circumferentially continuous main seal and a circumferentially continuous inboard seal spaced axially inward relative to the main seal.

### BRIEF DESCRIPTION OF THE DRAWINGS

FIG. 1 is a schematic view of a medical gas and vacuum system.

FIG. 2 is a cross-sectional view of an axially swage fitting employed in the medical gas and vacuum system of FIG. 1.

FIG. 3 is an enlarged partial cross-sectional view of a coupling body of the fitting of FIG. 2.

FIG. 4 is an enlarged partial cross-sectional view of one of the swage rings of the fitting of FIG. 2.

FIG. 5 is a partial cross-sectional view of the fitting of FIG. 2 having a tube or pipe of the medical gas and vacuum system received in the fitting's coupling body with one of the coupling's swage rings shown in a pre-install position on the coupling body.

FIG. 6 is a partial cross-sectional view of the fitting assembly of FIG. 5 shown with the swage ring in a fully installed position on the coupling body thereby sealing and mechanically connecting the coupling body to the tube or pipe received therein.

### DETAILED DESCRIPTION

Referring now to the drawings wherein the showings are for purposes of illustrating one embodiment only and are not to be construed as limiting the invention, a medical gas and vacuum system is shown and generally designated by reference numeral 10. In the illustrated embodiment, the medical gas and vacuum system 10 is provided at a medical facility 12 and includes at least one medical gas source 14 located at the medical facility. The system 10 can provide either a gas under pressure or provide a source of vacuum; thus, the at least one medical gas source 14 generally represents a medical gas source and/or an evacuation device which provides a vacuum to the system 10. Though the at least one medical gas source 14 is schematically illustrated as being a single tank, it is to be appreciated and understood by those skilled in the art that the at least one medical gas source could be a plurality of gas sources (e.g., a plurality of tanks) each holding or adapted to receive via vacuuming any type of gas used in the medical field (e.g., oxygen, air, nitrogen, nitrous oxide, etc.). Further, though gas source 14 is shown physically outside the schematically represented medical facility 12, it is to be understood and appreciated by those skilled in the art that the at least one medical gas source 14 could be located within the medical facility 12, such as at a central location.

The medical gas and vacuum system 10 further includes a plurality of spaced apart outlet ports, including first outlet port 16, second outlet port 18 and third outlet port 20 in the illustrated embodiment, disposed within the medical facility 12. The at least one medical gas source 14 is capable of providing a positive flow to deliver a supplied gas to one or more of the outlet ports 16,18,20 or a negative flow to vacuum a retrieved gas in through one or more of the outlet ports 16,18,20. Thus, a medical gas of the at least one medical gas source 14 can be discharged through one or more of the outlet ports 16,18,20 and therefore be referred to as a supplied gas. Alternatively, a medical gas can be drawn into one or more of the outlet ports 16,18,20 and therefore be referred to as a retrieved gas.

For delivering a supplied medical gas or vacuuming a retrieved medical gas, a pipeline network 22 fluidly connects the at least one medical gas source 14 to the plurality of outlet ports 16,18,20. The pipeline network 22 includes a plurality of pipeline fluid components through which medical gas flows, either being supplied under pressure or retrieved via vacuum. The plurality of pipeline fluid components forming the pipeline network 22 can include, for example, pipe members, control valves, pressure gauges, pressure regulators, manifolds, fittings for connecting these various fluid components to one another, and any other fluid component employable in a pipeline network of a medical gas and vacuum system.

In the schematically illustrated medical gas and vacuum system 10, the pipeline network 22 includes a main control valve 24 and a pressure gauge 26 located between the at least one medical gas source 14 and the plurality of outlet ports 16,18,20. Local control valves 28,30,32 are each respectively provided adjacent and associated with each of the plurality of outlet ports 16,18,20. For example, local control valve 28 is positioned adjacent outlet port 16 for controlling the supply or retrieval of medical gas through the outlet port 16. As shown, the network 22 further includes a plurality of pipe members 34, which can be formed of copper, for carrying the medical gas throughout the medical facility 14 and between the at least one source 14 and the plurality of outlet ports 16,18,20. For fluidly connecting the fluid components to one another and throughout the system 10, a plurality of fittings are provided, including elbow fittings 36, tee fittings 38 and coupling fittings 40.

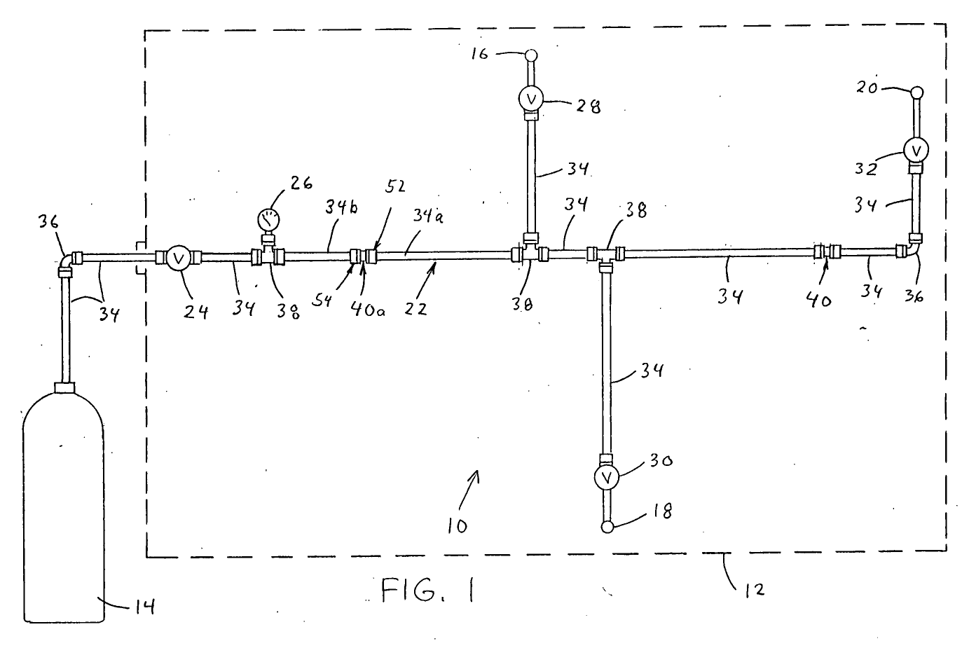

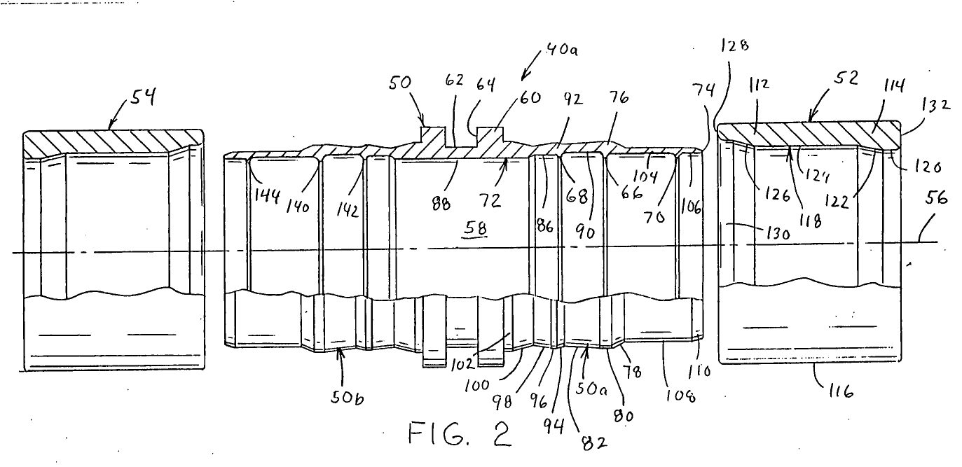

One or more of these fittings 36,38,40 can be an axially swaged fitting, which does not require brazing, or could more particularly be a lubrication-free axially swaged fitting. The pipeline network 22 of the illustrated system 10 includes at least one such axially swaged fitting for fluidly connecting at least a first fluid component to a second fluid component. In one embodiment, all fittings of the illustrated pipeline network 22 are axially swaged fittings connecting the fluid components of the network 22 to one another. With additional reference to FIG. 2, one fitting 40a of the coupling fittings 40 of FIG. 1 is shown as an axially swaged fitting for fluidly connecting a first fluid component 34a (one of the pipe members 34) of the pipeline network's plurality of fluid components to a second fluid component 34b (another of the pipe members 34) of the pipeline network's plurality of fluid components. The first and second fluid components or pipe member 34a,34b connected by the fitting 40a are generally adjacent one another and connected in end-to-end relation. However, those skilled in the art should understand and appreciate that the end-to-end coupling fitting 40a of FIG. 2 could be employed to couple any two adjacent pipe member 34 of FIG. 1 that are in end-to-end relation.

With specific reference now to FIG. 2, fitting 40a of the illustrated embodiment includes a coupling body 50 and a pair of swage rings 52,54 for coupling the two sections of tubing or pipe 34a,34b together. As illustrated, the components 50,52,54 of the illustrated fitting 40a are generally axisymmetrical about axis 56 and can optionally be formed of brass which is free machining with excellent machining properties. Brass fittings have been found to be relatively easier to machine and often have a lower material cost relative to fittings formed of other materials. The coupling body 50, also referred to herein as a connector body, of the illustrated fitting 40a includes a first portion or sleeve 50a (which forms the right side of the coupling body in FIG. 2) and a second portion or sleeve 50b (which forms the left side of the coupling body in FIG. 2). As will be described in more detail below, the first sleeve 50a is adapted to receive the first fluid component, i.e., pipe member 34a, and the second sleeve 50b is adapted to receive the second fluid component, i.e., pipe member 34b. As will also be described in more detail below, when the swage rings 52,54 are axially forced onto their respective sleeves 50a,50b with the pipe members 34a,34b received within a bore 58 of the coupling body 50, the sleeves become mechanically connected to and sealed with the pipe members 34a,34b. Thus, in the illustrated embodiment, the fitting 40a includes coupling body 50 which defines at least one bore 58 therein for receiving a first and second pipe members 34a,34b.

As will be understood and appreciated by those skilled the art, the sleeves 50a,50b are generally identical, except that they are axially mirrored relative to one another, and accordingly only first sleeve 50a will be described in significant detail herein. In the illustrated embodiment, the sleeve 50a includes a circumferential flange or ridge 60 extending radially outwardly from exterior outside surface 62 of the body 50. As will be described in more detail below, the ridge 60 includes a tool engaging surface 64 which is used in joining the sleeve 50a to the adjacent swage ring 52 when connecting the fitting 40a to the tube 34a (FIG. 1). The sleeve 50a further includes a plurality of spaced apart seals integrally formed with the coupling body 50 which extend radially into the bore 58 from the coupling body 50 for sealing and mechanically connecting the coupling body 50 to the pipe 34a received in the bore 58. The plurality of seals, including main seal 66, inboard or proximal seal 68 and outboard or distal seal 70, are each positioned on or extend from interior surface 72 of the coupling body 50 and into the bore 58. As used herein, the terms “proximal” and “distal,” as well as the terms “inboard” and “outboard,” are used to generally indicated relative axial spacing, such as from the exterior flange 60 or distal end 74 of the sleeve 50a. Thus, the distal or outboard seal is axially spaced relative to the flange 60 a greater distance than as the proximal or inboard seal 68.

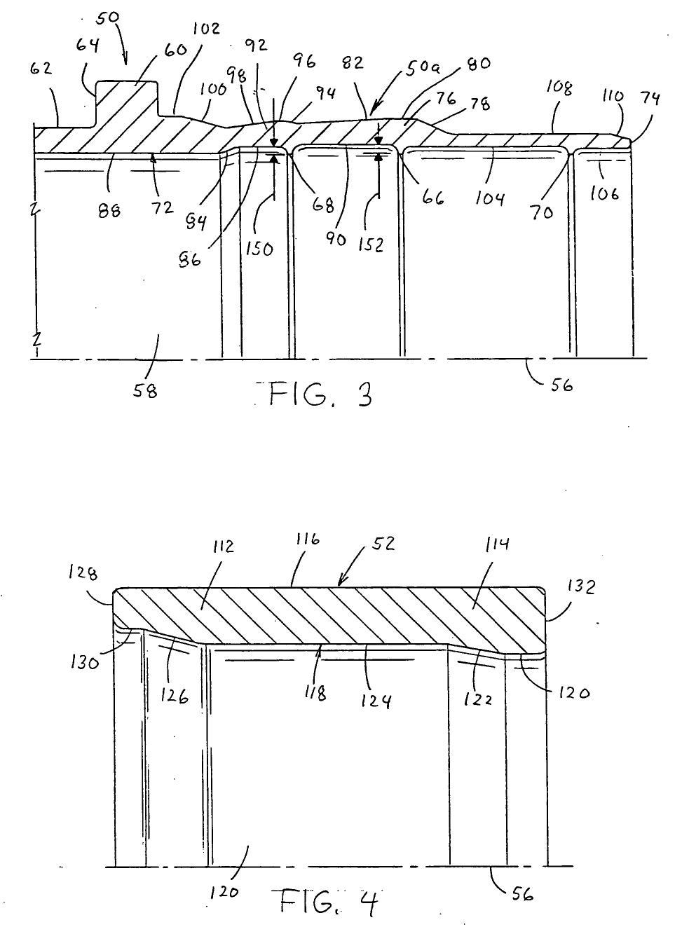

With additional reference to FIG. 3, the main seal 66 serves to provide a main fluid seal and mechanical connection with the pipe member 34a received within the sleeve 50a, as will be described in more detail below. In the illustrated embodiment, the main seal 66 is a single tooth axially spaced from and between the circumferential ridge 60, which is also referred to herein as a swage ring stop, and the distal end 74 of the sleeve 50a. Alternatively, the main seal 60 could be a plurality of teeth, such as the two-tooth main seal arrangement more fully described in commonly-owned U.S. Pat. No. 5,110,163, expressly incorporated herein by reference. A main seal compression land 76, also referred to herein as a seal urging feature or projection, is formed on and extends radially from the outside surface 62 adjacent the main seal 66. In the illustrated embodiment, the land 76 is directly opposite the main seal 66 and includes an abrupt upslope ramp 78, plateau area 80 and a downslope ramp 82 which is longer and more gradual than the upslope ramp 78.

The inboard or proximal seal 68 is located between the main seal 66 and the ridge 60, axially spaced from each. Like the main seal 66, the inboard seal 68 is adapted to provide a fluid seal and a mechanical connection with the pipe member 34a. In the illustrated embodiment, the inboard seal 68 is a single tooth, but it is to be appreciated by those skilled in the art that the inboard seal could be formed by a plurality of teeth, which could be separated from one another by one or more appropriate grooves. The interior surface 72 includes a tapered section 84 between the inboard seal 68 and the exterior flange 60 such that the seal 68 extends from the sleeve 50a immediately adjacent a recessed portion 86, also referred to herein as a first undercut or undercut surface, of the interior surface 72. The recessed portion 86 has a diameter greater than a portion 88 of the surface 72 immediately opposite the exterior flange 60. A diametrically constant section 90, also referred to herein as a second undercut or undercut surface, of the interior surface 72 is provided between the inboard seal 68 and the main seal 66.

The undercut surface 86 defines undercut 150 and undercut surface 90 defines undercut 152, both of which are considered reduced undercuts, particularly relative to prior art swage ring-type fittings. In particular, less material is removed from the surface 72 to create the undercuts 150 and 152. This has the advantage of reducing machining required for manufacturing the fitting 40a. Moreover, the reduced undercuts 150,152 also increase the thickness of the sleeve 50a, particularly immediately adjacent the inboard seal 68. Such increase in the body wall thickness reduces a potential for buckling of the sleeve 50a as the drive ring 52 is installed on the coupling body 50. Absent the reduced undercuts 150,152, buckling may be more likely, particularly when the fitting 40a is manufactured of brass and/or used without lubricant between the drive ring 52 and the coupling body 50.

An inboard compression land 92, also referred to herein as an inboard or proximal seal urging feature or projection, is formed on and extends radially from the outside surface 62 adjacent the inboard seal 68. In the illustrated embodiment, the land 92 is positioned directly opposite the inboard seal 68 and includes a slight, but abrupt, upslope ramp 94 extending radially outward from the gradual downslope ramp 82, a plateau area 96, and a gradual downslope ramp 98. The configuration of the inboard land 92, particularly the gradually downsloping ramp 98, can have the effect of assisting in or facilitating driving the seals 66,68 into the pipe member 34a. In the illustrated embodiment, the plateau area 96 is immediately opposite the inboard seal 68, the ramp 94 extends from the plateau area 92 to the ramp 82 of the main seal land 76 and the taper 98 extends from the plateau area 96 to a position axially aligned with the tapered portion 84. An upslope ramp 100 extends from the gradual downslope ramp 98 radially outwardly to another plateau area 102 immediately adjacent the exterior flange 60.

The outboard or distal seal 70 is located between the main seal 66 and the distal end 74, axially spaced from each. Like the seals 66,68, the outboard seal 70 is adapted to provide a fluid seal and a mechanical connection with the pipe member 34a. In the illustrated embodiment, the outboard seal 70 is a single tooth which can be referred to as the outboard isolation tooth. The outboard isolation tooth 70 is positioned adjacent the distal end 74 and axially spaced inwardly slightly therefrom. Diametrically constant portion 104, which also forms a reduced undercut like undercuts 150,152, of the interior surface 72 separates the outboard seal 70 from the main seal 66. Another diametrically constant section 106, which can also define a reduced undercut like those already described herein, separates the distal end 74 from the outboard seal 70. It is to be appreciated by those skilled in the art that the outboard seal 70 can alternately be formed of a plurality of teeth, separated from one another by one or more appropriate grooves.

Though not depicted in the illustrated embodiment, the sleeve 50a can further include at least one anti-torsion ridge, such as a ridge located between the main seal 66 and the outboard seal 70. Such a torsion ridge could be provided for carrying torsion loads between the coupling body 50 and the pipe members 34a,34b to which it is mechanically connected. In one embodiment, a torsion ridge is provided in a location spaced axially outwardly from the main seal 66 a sufficient distance so that a reduction of the diameter of pipe member 34a by the main seal 66 does not interfere with engagement between this torsion ridge and the pipe member 34a. This ridge can optionally include friction surfaces formed by knurling, broaching or the like to better resist torsion loads. Further details concerning such an anti-torsion ridge and its function are provided in commonly-owned U.S. Pat. Nos. 6,692,040 and 6,131,964, both expressly incorporated herein by reference. As taught in the '040 patent, in an alternate embodiment, the outboard isolation tooth 70 can be replaced and/or serve as a distal torsion ridge, in addition to or in replacement of any other provided torsion ridges. Such distal torsion ridge would primarily serve to carry torsion loads between the coupling body 50 and the pipe member 34a. This alternate distal torsion ridge could include a frictional surface formed by knurling, broaching or the like to better resist torsion loads.

The outside surface 62 of the sleeve 50a includes a distal portion 108 extending between the land 76 and the distal end 74. The distal portion 108 has a relatively smaller diameter than each of the lands 76,96, the flange 60 and a portion of the exterior surface 62 adjacent the flange 60. Although not illustrated, the distal portion 108 can include an increased friction section or locking mechanism adjacent the distal end 42, such as described in the referenced '040 and '964 patents. Distal end 74 includes taper 110 preferably having a taper angle of about twenty degrees (20°), which assists in initially installing the swage ring 52 onto the coupling body 50.

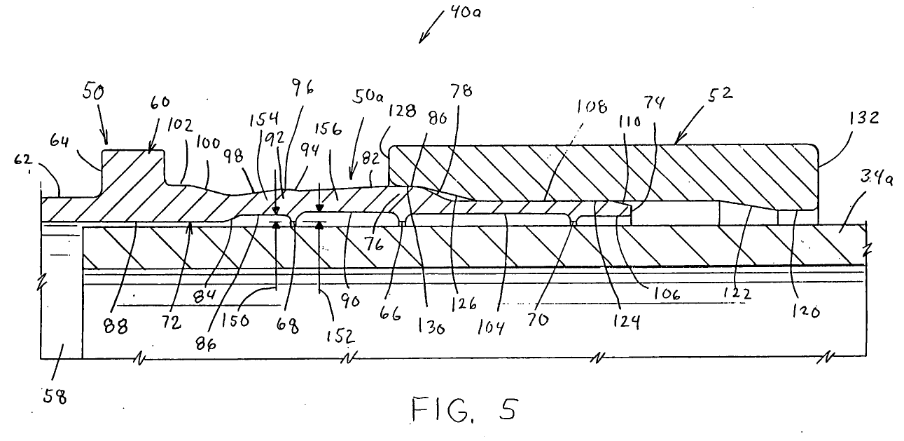

The swage ring 52, also referred to herein as a drive ring, is sized to be annularly received or fitted over and axially forced along the sleeve 50a toward the flange 60 for urging the seals 66,68,70 into the pipe member 34a to seal and mechanically connect the body 50 with the pipe member 34a. More specifically, with additional reference to FIG. 4, the swage ring 52 includes a proximal portion 112 and a distal portion 114. In the illustrated embodiment, the swage ring 52 includes an exterior surface 116 having a relatively constant outside diameter. As illustrated, the distal portion 114 is generally thicker than the proximal portion 112. The swage ring 52 further includes an interior surface 118 defining a throughhole 119 into which the coupling sleeve 50a is received when the ring 52 is installed onto the coupling body 50.

More particularly, the interior surface 118 includes distal compression surface or portion 120, tapered surface or portion 122 and a proximal compression surface 124. The tapered section 122 connects the distal portion 120 to the proximal portion 124. As shown, the proximal compression surface 124 has an increased diameter relative to the distal compression surface 120. Though not shown in the illustrated embodiment, the proximal compression surface 124 can include a kick-down feature such as described in U.S. Pat. No. 5,709,418, expressly incorporated herein by reference. A proximal taper 126 of the surface 118 flares open adjacent proximal end 128 of the swage ring 52 for facilitating easier insertion of the sleeve 50a, and particularly the lands 76,92 of the sleeve 50a, into the throughhole 120 when the ring 52 is installed onto the body 50. A proximal section 130, with a relatively constant diameter, is provided immediately adjacent the proximal end 128.

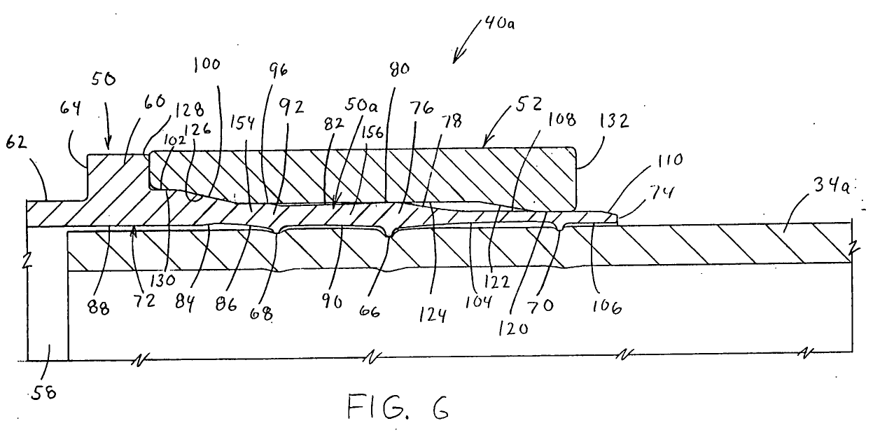

With additional reference to FIG. 5, the swage ring 52 is shown partially installed or preassembled on the coupling body 50 in a pre-install or distal position. In this position, the swage ring taper 126 is adjacent the main seal ramp 78. Through an interference fit, the swage ring 52 is maintained and can be shipped to customers in the pre-install position on the coupling body 50, which facilitates ease of use and installation by the ultimate end-users. Though not illustrated, the swage ring 54 can likewise be pre-installed onto the sleeve 50b. In particular, ease of use is facilitated by the fitting 40a being maintained as a partially assembled one-piece assembly, as opposed to the components 50,52,54 of the assembly being multiple pieces separate from one another.

Specifically, the diameter of the proximal compression portion 124 of the swage ring 52 is slightly smaller than the exterior diameter of the distal portion 108 so that the interference fit is formed when the swage ring 52 is axially forced onto the connector body sleeve 50a to the pre-install position of FIG. 5. Though the interference fit causes the sleeve 50a to partially contract radially, a sufficient inner diameter is maintained for all the seals 66,68,70 so the pipe member 34a can be easily inserted into the bore 58 defined by the connector body inner surface 72. The sufficient inner diameter is large enough to accommodate a manufacturing tolerance of the coupling body 50, to accommodate a manufacturing tolerance of the pipe member 34a, and to maintain a clearance gap between the sleeve 50a and the pipe member 34a that allows relatively easy insertion of the pipe into the bore 58.

To fully install the swage ring 52 onto the sleeve 50a with the pipe member 34a inserted therein for purposes of mechanically connecting and sealing the fitting 40a to the pipe member 34a, an installation tool (not shown) can be used to further force the swage ring 52 onto the sleeve 50a toward the tool engaging flange 60. One suitable installation tool is described in commonly-owned U.S. Pat. No. 5,305,510, expressly incorporated herein by reference. As will be known and appreciated by those skilled in the art, the installation tool has opposed jaws that engage the tool engaging surface 64 of the flange 60 and a swage ring distal end 132. The jaws are then actuated to force or press the swage ring 52 toward the flange 60 to a final installation position (shown in FIG. 6). Axial movement of the swage ring 52 onto the coupling body 50 with the pipe member 34a inserted therein causes radial movement of the coupling body 50, and particularly the seals 66,68,70 of the fitting body, toward or into the pipe member 34a to create seals and mechanical connections therewith. At least the coupling body 50 and the pipe member 34a can be formed of metal (for example, the fitting 40a can be brass and the pipe member 34a can be copper) so that the mechanical connection between the fitting 40a and the pipe member is a metal to metal seal. The metal to metal seal between the fitting 40a and the pipe members 34a can have temperature and pressure ratings that exceed, or are at least not less than, that of a brazed joint. In any case, the mechanical connection between the coupling body 50 and the pipe member 34a is generally permanent and nonseparable after the swage ring 52 is fully fitted onto the sleeve 50a.

In one application, the swage ring 52 is urged onto the sleeve 50a without the use of lubricant. Without lubricant, the fitting 40a can be employed as an oxygen-clean fluid component appropriate for use in medical gas and vacuum distribution pipeline systems. When the fitting 40a is formed of brass, installation of the swage ring 52 onto the coupling body 50 occurring without the use of a lubricant which is required with other fitting materials due to the high frictional coefficient present with other materials. The reduced undercut 150 which results in a thickened sleeve area 154 serves to resist buckling of the sleeve 50a, particularly when the swage ring 52 is installed without lubricant. Likewise, the reduced undercut 152 results in a thickened area 156 which can also resist buckling of the sleeve 50a particularly when the swage ring is used without lubricant. The undercuts adjacent surfaces 104,106 can also serve the same function.

Certain other materials, such as certain stainless steels, exhibit a phenomenon known as galling which can negatively affect the performance of the fitting installation if not modified with the use of a lubricant. This tends not to occur when the fitting 40a is brass due to brass being a bearing material. In any case once the swage ring 52 is fully installed on the coupling body 50, the fitting 40a provides an axially swaged, elastic strain preload fitting that has pressure and temperature ratings greater than those found on a brazed joint. Moreover, when the drive ring is fully installed on the connector body, the mechanical connection between the fitting 40a and the pipe member 34a received within the coupling body is permanent and nonseparable.

Preferably, the design or configuration of the coupling body 50 is such that when the swage ring 52 is urged onto the coupling body 50, the main seal 66 is urged into substantial biting and sealing engagement with the outer surface of the pipe member 34a. In comparison, the outboard seal 70 and the inboard seal 68 are each preferably designed to make at least a minimal bite into the outer surface of the pipe member 34a. Also, preferably, the coupling body 50 is configured so that the inboard seal 68 bites into the pipe members 34a an amount substantially the same as the outboard seal 70 and both seals 68,70 bite into the pipe an amount equal to or less than the amount the main seal 66 bites into the pipe 66. As will be appreciated by those skilled in the art, the inboard and outboard seals 68,70 function to prevent pivoting or rocking of the pipe member 34a about a fulcrum established where the main seal 66 bites into the pipe member 34a thereby preventing the pipe member from bending or flexing about the main seal 66, thus preventing, or at least reducing the likelihood of, relative motion between the main seal 66 and the pipe member 34a and thus leakage at the point where the main seal 66 engages the pipe member 34a.

As should be readily appreciated by those skilled in the art, the second pipe member or fluid component 34b can be received in the bore 58 within the sleeve 50b and the swage ring 54 can be fitted over the coupling body 50 to seal and mechanically connect a second plurality of seals with the second pipe member 34b in the same manner as discussed in reference to the first pipe member 34a being received in the sleeve 50a and having the swage ring 52 fitted over the sleeve 50a. The second plurality of seals can include a main seal 140, a proximal or inboard seal 142 and a distal or outboard seal 144, all extending radially into the bore 58. With the fitting 40a mechanically connected and sealed to both pipe members 34a,34b, a continuous fluid path is established through the members 34a,34b and the fitting 40a.

Though only fitting 40a has been described in detail as an axially swage fitting, any of the fittings 36,38,40 of the pipeline network 22 can be axially swaged fittings. Moreover, any of the fittings 36,38,40 can be axially swaged fittings having a configuration as described in relation to the fitting 40a (i.e., having a sleeve with a plurality of seals extending therefrom for sealing and mechanically connecting to a pipe member received in the sleeve when a swage ring is axially installed or fitted onto the sleeve). Moreover, those skilled in the art will understand and appreciate that the exact configuration of an axially swaged fitting employed in the pipeline network 22 can vary and is not limited to the fittings 36,38,40 shown and described, and certainly need not include exactly two sleeves in a coaxial configuration, as described in detail in reference to fitting 40a. For example, the axially swaged fitting of the network 22 could be integrally formed or adapted to connect with another component or type of fitting, and may have any number of sleeves extending at various locations therefrom for connecting to one or more corresponding tubes. A particular example could be a combination fitting and ball-valve wherein the fitting is combinable with a ball-valve in a similar manner as described in commonly owned U.S. Pat. No. 6,467,752, expressly incorporated herein by reference. For example, one or more of the valves 24,28,30,32 could be integrally formed with an axially swage fitting, as could any other of the pipeline's fluid components (e.g., pressure gauge 26).

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A medical gas and vacuum system of a medical facility, comprising:
at least one medical gas source located at the medical facility, said at least one medical gas source capable of providing a positive flow to deliver a supplied gas or a negative flow to vacuum a retrieved gas;
a plurality of spaced apart outlet ports disposed within the medical facility for discharging said supplied gas and vacuuming said retrieved gas;
a pipeline network fluidly connecting said at least one medical gas source to said plurality of outlet ports, said pipeline network including a plurality of pipeline fluid components through which said gas flows; and
at least one axially swaged fitting fluidly connecting at least a first fluid component of said plurality of pipeline fluid components to a second fluid component of said plurality of pipeline fluid components, said fitting including a coupling body defining at least one bore for receiving said first fluid component, a plurality of seals extending radially into said at least one bore from said coupling body and a swage ring fitted over said coupling body to seal and mechanically connect said plurality of seals to said first fluid component received in said at least one bore.

2. The medical gas and vacuum system of claim 1 wherein said plurality of pipeline fluid components includes at least one of a pipe member, a control valve, a pressure gauge, a pressure regulator and a manifold.

3. The medical gas and vacuum system of claim 1 wherein said second fluid component is received in said at least one bore and a second swage ring is fitted over said coupling body to seal and mechanically connect a second plurality of seals extending radially into said at least one bore to said second fluid component received in said at least one bore.

4. The medical gas and vacuum system of claim 1 wherein said plurality of seals are integrally formed with said coupling body of metal and said first fluid component is metal so that the mechanical-connection between said at least one axially swaged fitting and said first fluid component is a metal to metal seal.

5. The medical gas and vacuum system of claim 4 wherein said metal to metal seal has pressure and temperature ratings not less than that of a brazed joint.

6. The medical gas and vacuum system of claim 1 wherein a mechanical connection between said coupling body and said first fluid component is generally permanent and nonseparable after said swage ring is fully fitted over said coupling body.

7. The medical gas and vacuum system of claim 1 wherein said plurality of seals includes a main seal and an inboard seal axially spaced from said main seal a distance sufficient to allow said main seal and said inboard seal to form seals and mechanical connections by engaging and deforming said first fluid component without interfering with one another.

8. The medical gas and vacuum system of claim 7 wherein a reduced undercut is provided immediately adjacent said inboard seal.

9. The medical gas and vacuum system of claim 8 wherein the reduced undercut causes the coupling body to have a thickened area adjacent and axially inwardly relative to the inboard seal to resist buckling.

10. The medical gas and vacuum system of claim 9 wherein said coupling body is brass and said swage ring is fitted onto said coupling body without a lubricant.

11. The medical gas and vacuum system of claim 7 wherein said coupling body further includes an outboard seal extending radially into said at least one bore for further sealing and mechanically connecting to said first fluid component received in said at least one bore.

12. The medical gas and vacuum system of claim 11 wherein said swage ring has an interior surface defining a throughhole for fitting over said coupling body, said interior surface including a proximal compression surface having an appropriate proximal surface diameter for sealing and mechanically connecting said main seal and said inboard seal to said first fluid conduit, and further including a distal compression surface having an appropriate distal surface diameter that is smaller than said proximal surface diameter for sealing and mechanically connecting said outboard seal to said first fluid conduit.

13. The medical gas and vacuum system of claim 7 wherein said coupling body includes at least one seal land adjacent said plurality of seals, said at least one seal land extends radially outwardly from an exterior surface of said coupling body to facilitate sealing and mechanically connecting said plurality of seals to said first fluid component when said swage ring is fitted over said coupling body.

14. The medical gas and vacuum system of claim 1 wherein said coupling body includes an exterior radial flange having an engaging surface for enabling an installation tool to forcibly fit said swage ring onto said coupling body by applying a compression force to said engaging surface and to an engaging surface of said swage ring.

15. The medical gas and vacuum system of claim 7 wherein said coupling body includes at least one anti-torsion ridge extending radially into said at least one bore, said anti-torsion ridge having a frictional surface for resisting torsion between said coupling body and said first fluid component.

16. The medical gas and vacuum system of claim 1 wherein said coupling body includes a frictional area on an outside surface thereof and adjacent a distal end of said coupling body for limiting axial movement of said swage ring relative to said coupling body.

17. The medical gas and vacuum system of claim 1 wherein said plurality of seals includes a main seal and an inboard seal, a reduced radial undercut is provided adjacent said inboard seal to reduce buckling of said coupling body occurring during fitting of said swage ring onto said coupling body.

18. The medical gas and vacuum system of claim 1 wherein at least one of said coupling body and said swage ring is configured to apply a restoring load to a main seal of said plurality of seals to further seal and mechically connect said main seal to said fluid component after an inboard and an outboard seal, both of said plurality of seals, are sealed and mechically connected to said fluid component.

19. A lubrication-free fitting for making connections in a medical gas and vacuum system, comprising:
a coupling body having an inside surface defining a bore for receiving a pipe of the medical gas and vacuum system;
a ring fitting over said coupling body for sealing and mechanically connecting said coupling body to the pipe;
an axisymmetrical main seal formed on said inside surface of said coupling body that seals and connects to the pipe when said ring is installed on said coupling body;
an axisymmetrical inboard seal formed on said inside surface of said coupling body, said inboard seal axially spaced from said main seal, said inboard seal seals and connects to the pipe when said ring is installed on said coupling body; and
an axisymmetrical outboard seal formed on said inside surface of said coupling body and axially spaced from said main seal in a direction opposite said inboard seal, said outboard seal seals and connects to the pipe when said ring is installed on said coupling body.

20. A medical gas and vacuum system of a medical facility, comprising:
at least one medical gas source located at the medical facility;
at least one outlet port located inside the medical facility;
at least one pipe supply line formed of at least first and second metal pipe supply line members fluidly connecting said at least one medical gas source to said at least one outlet port; and
at least one axially swaged fitting fluidly connecting said at least first and second metal pipe supply line members to one another, said at least one axially swaged fitting including:
a metal coupling body having a first open end and a second open end with a bore extending between said first and second open ends, said first pipe supply line member received through said first open end into said bore and said second pipe supply line member received through said second open end into said bore,
a first plurality of seals integrally formed with and extending from said coupling body into said bore from said inside surface,
a first swage ring fitted over said coupling body adjacent said first open end for permanently and nonseparably sealing and mechanically connecting said first plurality of seals with said first pipe supply line,
a second plurality of seals integrally formed with and extending from said coupling body into said bore from said inside surface, and
a second swage ring fitted over said coupling body adjacent said second open end for permanently and nonseparably sealing and mechanically connecting said second plurality of seals with said second pipe supply line member,
wherein said first and second sets of said plurality of seals each include a circumferentially continuous main seal and a circumferentially continuous inboard seal spaced axially inward relative to said main seal.
